(19) United States
(12) Patent Application Publication
(10) Pub. No.: US 2026/0280150 A1
(43) Pub. Date: Sep. 17, 2026

(54) ANTENNA

(71) Applicants: BEIJING BOE SENSOR TECHNOLOGY CO., LTD., Beijing (CN); BOE Technology Group Co., Ltd., Beijing (CN)

(72) Inventors: Wenxue Ma, Beijing (CN); Yunnan Jin, Beijing (CN); Sihui Bao, Beijing (CN); Liang Guo, Beijing (CN)

(73) Assignees: BEIJING BOE SENSOR TECHNOLOGY CO., LTD., Beijing (CN); BOE Technology Group Co., Ltd., Beijing (CN)

(21) Appl. No.: 19/166,170

(22) PCT Filed: Sep. 25, 2023
(86) PCT No.: PCT/CN2023/120954

§ 371 Date: Sep. 17, 2025

(51) Int. Cl. H01Q 21/26; H01Q 1/52; H01Q 19/10; H01Q 21/08

(52) U.S. Cl. CPC H01Q 21/26; H01Q 1/523; H01Q 19/108; H01Q 21/08

(57) ABSTRACT

An antenna is provided. The antenna includes a plurality of radiating elements. A respective radiating element of the plurality of radiating elements includes a dielectric substrate, one or more radiating oscillators on the dielectric substrate, and one or more conductors configured to optimize polarization isolation of the antenna. The one or more conductors are spaced apart from the one or more radiating oscillators. The plurality of radiating elements are arranged along a first direction, and the one or more conductors are arranged along a direction substantially parallel to a second direction, the second direction being different from the first direction, and the first direction and the second direction intersecting each other.

### TECHNICAL FIELD

The present invention relates to an antenna.

### BACKGROUND

Antennas, as devices for converting guided waves into free-space propagating waves, play an irreplaceable role in the field of wireless communication. As an indispensable and critical component in mobile communication systems, their performance directly influences the overall performance of the entire wireless network.

### SUMMARY

In one aspect, the present disclosure provides an antenna, comprising a plurality of radiating elements; wherein a respective radiating element of the plurality of radiating elements comprises a dielectric substrate, one or more radiating oscillators on the dielectric substrate, and one or more conductors configured to optimize polarization isolation of the antenna; wherein the one or more conductors are spaced apart from the one or more radiating oscillators; and the plurality of radiating elements are arranged along a first direction, and the one or more conductors are arranged along a direction substantially parallel to a second direction, the second direction being different from the first direction, and the first direction and the second direction intersecting each other.

Optionally, the respective radiating element has a substantial mirror symmetry with respect to a first plane perpendicular to the dielectric substrate and intersecting the one or more conductors; and the first plane is substantially parallel to the second direction.

Optionally, the respective radiating element has a substantial mirror symmetry with respect to a second plane perpendicular to the dielectric substrate and substantially parallel to the first direction; the second plane is not intersecting with the one or more conductors; and the second plane is substantially parallel to the first direction.

Optionally, the antenna further comprises a plurality of coupling baluns connected to the plurality of radiating elements, respectively; wherein a respective coupling balun of the plurality of coupling baluns comprises a first feeding balun and a second feeding balun intersecting each other; in a cross-section along a plane intersecting the plurality of coupling baluns and parallel to surfaces of the plurality of radiating elements, the respective coupling balun has a X shape; the first feeding balun comprises a first dielectric substrate, a first balun trace, and a first ground; and the second feeding balun comprises a second dielectric substrate, a second balun trace, and a second ground.

Optionally, the respective radiating element further comprises one or more first slots extending through the one or more radiating oscillators; the first ground comprises one or more first solder pads; the second ground comprises one or more second solder pads; and the one or more first solder pads and the one or more second solder pads are inserted into the one or more first slots.

Optionally, the antenna further comprises a first power divider network configured to provide feeding to the plurality of radiating elements; wherein the first power divider network is connected to the plurality of coupling baluns, and the plurality of coupling baluns are connected to the plurality of radiating elements; the first power divider network comprises a first power divider sub-network configured to provide feeding to a first group of coupling baluns and a second power divider sub-network configured to provide feeding to a second group of coupling baluns; and the first power divider network utilizes unequal power division.

Optionally, the first power divider sub-network comprises one or more first power divider traces; the second power divider sub-network comprises one or more second power divider traces; at least one of the one or more first power divider traces is connected to the first balun trace of a corresponding first feeding balun; at least another of the one or more first power divider traces is connected to the second balun trace of a corresponding second feeding balun; at least one of the one or more second power divider traces are connected to the first balun trace of a corresponding first feeding balun; and at least another of the one or more second power divider traces are connected to the second balun trace of a corresponding second feeding balun.

Optionally, the antenna further comprises one or more coaxial lines configured to provide ground for the antenna; wherein the first power divider sub-network comprises one or more third solder pads; the second power divider sub-network comprises one or more fourth solder pads; and the one or more third solder pads and the one or more fourth solder pads are connected to the one or more coaxial lines.

Optionally, the antenna further comprises a second power divider network configured to connect the first power divider sub-network with the second power divider sub-network.

Optionally, the antenna further comprises a first coaxial line and a second coaxial line; wherein the second power divider network is connected to the first coaxial line; the first coaxial line is connected to the first power divider sub-network; the second power divider network is connected to the second coaxial line; and the second coaxial line is connected to the second power divider sub-network.

Optionally, the second power divider network includes one or more third power divider traces; the first power divider sub-network comprises one or more first power divider traces; the second power divider sub-network comprises one or more second power divider traces; one of the one or more third power divider traces is connected to one of the one or more first power divider traces and one of the one or more second power divider traces; and another of the one or more third power divider traces is connected to another of the one or more first power divider traces and another of the one or more second power divider traces.

Optionally, the antenna further comprises one or more isolators; wherein a respective isolator of the one or more isolators spaces apart two adjacent radiating elements in a same group of radiating elements.

Optionally, the antenna further comprises a first reflector; wherein a respective isolator of the one or more isolators comprises an isolation strip and one or more supports configured to support the isolation strip; and the isolation strip and the plurality of radiating elements have a substantially same height relative to the first reflector.

Optionally, the antenna further comprises a first reflector; wherein a cross-section of the first reflector along a plane substantially parallel to the second direction and perpendicular to surfaces of the plurality of radiating elements has a U shape.

Optionally, the first reflector comprises a first portion, a second portion, and a third portion; the second portion and the third portion extend along a direction substantially parallel to the first direction; the first portion is connected to the second portion, and is connected to the third portion; an included angle between the first portion and the second portion is in a range of 85 degrees to 95 degrees; and an included angle between the first portion and the third portion is in a range of 85 degrees to 95 degrees.

Optionally, the antenna further comprises a second reflector on a side of the first reflector away from the plurality of radiating elements; one or more radiofrequency traces; one or more fourth openings extending through the first reflector; and one or more fifth openings extending through the second reflector; wherein the one or more radiofrequency traces extend through the one or more fourth openings and the one or more fifth openings.

Optionally, a respective conductor of the one or more conductors has a V shape, a T shape, a π shape, or an open triangular ring shape.

Optionally, the one or more conductors comprise one or more first conductors and one or more second conductors; a respective first conductor of the one or more first conductors spaces apart a respective second conductor of the one or more second conductors from the one or more radiating oscillators; the one or more first conductors are configured to operate within high-frequency band; and the one or more second conductors are configured to operate within low-frequency band.

Optionally, the respective radiating oscillator has a ring shape.

Optionally, an outer periphery of the respective radiating oscillator has a hexagonal shape; an inner periphery of the respective radiating oscillator has a heptagonal shape; and four vertices of four radiating oscillators surround a center of the respective radiating element.

### BRIEF DESCRIPTION OF THE FIGURES

The following drawings are merely examples for illustrative purposes according to various disclosed embodiments and are not intended to limit the scope of the present invention.

FIG. 1 is a plan view of an antenna in some embodiments according to the present disclosure.

FIG. 2 is a plan view of a first reflector, power divider networks, and coupling baluns in an antenna in some embodiments according to the present disclosure.

FIG. 3 is a first side view of an antenna in some embodiments according to the present disclosure.

FIG. 4 is a second side view of an antenna in some embodiments according to the present disclosure.

FIG. 5 is a third side view of an antenna in some embodiments according to the present disclosure.

FIG. 6 is a perspective view of an antenna in some embodiments according to the present disclosure.

FIG. 7A is a schematic diagram illustrating the structure of a respective radiating element in some embodiments according to the present disclosure.

FIG. 7B is a schematic diagram illustrating the structure of a respective radiating element in some embodiments according to the present disclosure.

FIG. 7C is a schematic diagram illustrating the structure of a respective radiating element in some embodiments according to the present disclosure.

FIG. 7D is a schematic diagram illustrating the structure of a respective radiating element in some embodiments according to the present disclosure.

FIG. 7E is a schematic diagram illustrating the structure of a respective radiating element in some embodiments according to the present disclosure.

FIG. 8 is a plan view of a first side of a first feeding balun in some embodiments according to the present disclosure.

FIG. 9 is a plan view of a second side of a first feeding balun in some embodiments according to the present disclosure.

FIG. 10 is a plan view of a first side of a second feeding balun in some embodiments according to the present disclosure.

FIG. 11 is a plan view of a second side of a second feeding balun in some embodiments according to the present disclosure.

FIG. 12 is a schematic diagram illustrating the structure of a first power divider sub-network in some embodiments according to the present disclosure.

FIG. 13 is a schematic diagram illustrating the structure of a second power divider sub-network in some embodiments according to the present disclosure.

FIG. 14 is a schematic diagram illustrating the structure of a second power divider network in some embodiments according to the present disclosure.

FIG. 15 is a schematic diagram illustrating the structure of an isolation strip in some embodiments according to the present disclosure.

FIG. 16 is a schematic diagram illustrating the structure of a support in some embodiments according to the present disclosure.

FIG. 17 is a plan view of a first reflector in some embodiments according to the present disclosure.

FIG. 18 is a cross-sectional view of a first reflector in some embodiments according to the present disclosure.

FIG. 19 is a perspective view of a first reflector in some embodiments according to the present disclosure.

FIG. 20 is a plan view of a second reflector in some embodiments according to the present disclosure.

FIG. 21 is a perspective view of a casing in some embodiments according to the present disclosure.

FIG. 22 is a graph showing voltage standing wave ratio values of an antenna in some embodiments according to the present disclosure.

FIG. 23 is a graph showing S21 parameters of an antenna in some embodiments according to the present disclosure.

FIG. 24 is a graph showing efficiency values of an antenna in some embodiments according to the present disclosure.

FIG. 25 is a graph showing gain values of an antenna in some embodiments according to the present disclosure.

FIG. 26 is a graph showing axial cross-polarization ratio values of an antenna in some embodiments according to the present disclosure.

FIG. 27 is a graph showing front-to-back ratio values of an antenna in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

With the continuous development of mobile communication technology, the demands for communication quality and capacity have been increasing. Currently, more and more frequency bands are being developed and utilized, which leads to higher requirements for antenna bandwidth. Designing antennas with broadband, compact, and lightweight characteristics has become increasingly important and urgent. Dual-polarized antennas can transmit and receive simultaneously, reducing the number of antennas and effectively improving the channel capacity. Consequently, research on dual-polarized wideband antennas has gradually become a major hotspot.

The present disclosure provides, inter alia, an antenna that substantially obviate one or more of the problems due to limitations and disadvantages of the related art. In some embodiments, the antenna includes a plurality of radiating elements. Optionally, a respective radiating element of the plurality of radiating elements comprises a dielectric substrate, one or more radiating oscillators on the dielectric substrate, and one or more conductors configured to optimize polarization isolation of the antenna. Optionally, the one or more conductors are spaced apart from the one or more radiating oscillators. Optionally, the plurality of radiating elements are arranged along a first direction, and the one or more conductors are arranged along a direction substantially parallel to a second direction, the second direction being different from the first direction, and the first direction and the second direction intersecting each other.

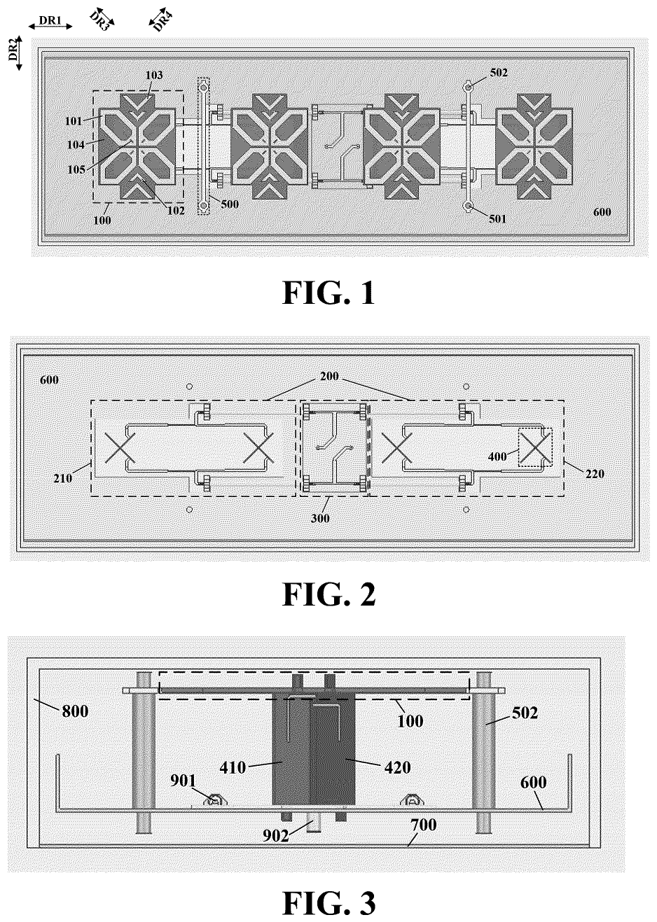

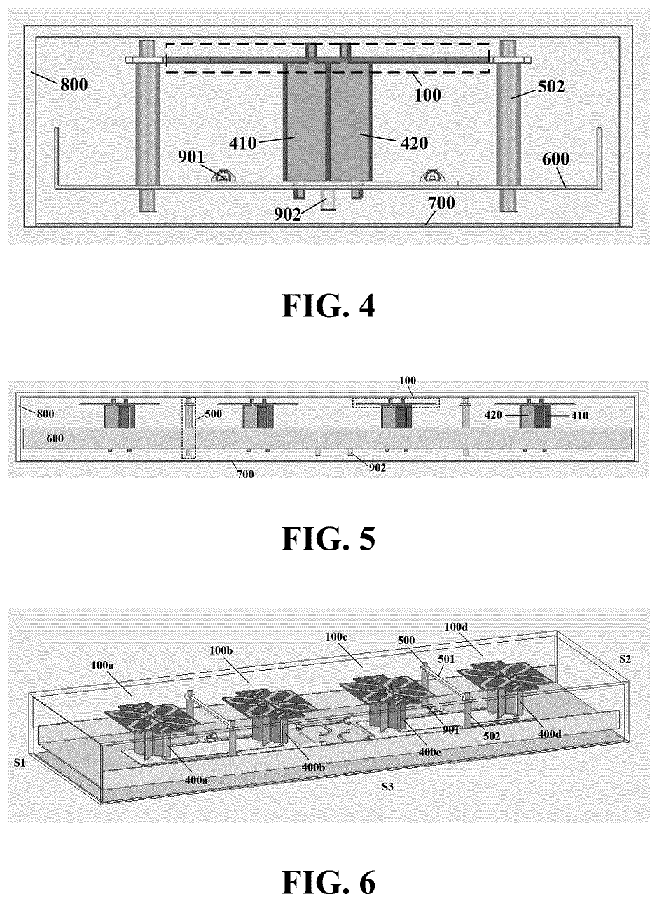

FIG. 1 is a plan view of an antenna in some embodiments according to the present disclosure. FIG. 2 is a plan view of a first reflector, power divider networks, and coupling baluns in an antenna in some embodiments according to the present disclosure. FIG. 3 is a first side view of an antenna in some embodiments according to the present disclosure. FIG. 4 is a second side view of an antenna in some embodiments according to the present disclosure. FIG. 5 is a third side view of an antenna in some embodiments according to the present disclosure. FIG. 6 is a perspective view of an antenna in some embodiments according to the present disclosure. FIG. 3 is a side view of a first side S1 as denoted in FIG. 6. FIG. 4 is a side view of a second side S2 as denoted in FIG. 6. FIG. 5 is a side view of a third side S3 as denoted in FIG. 6. Referring to FIG. 1 to FIG. 6, the antenna in some embodiments includes a plurality of radiating elements 100. In some embodiments, a respective radiating element of the plurality of radiating elements 100 includes a dielectric substrate 104, one or more radiating oscillators 101 on the dielectric substrate 104, and one or more conductors configured to optimize polarization isolation of the antenna.

In some embodiments, the one or more conductors are spaced apart from the one or more radiating oscillators 101. Optionally, the one or more conductors are spaced apart from each other. In the particular example depicted in FIG. 1, the one or more conductors includes one or more first conductors 102 and one or more second conductors 103. In some embodiments, a respective first conductor of the one or more first conductors 102 spaces apart a respective second conductor of the one or more second conductors 103 from the one or more radiating oscillators 101. In some embodiments, the one or more first conductors 102 are configured to operate within high-frequency band, and the one or more second conductors 103 are configured to operate within low-frequency band. In one particular example, the respective first conductor has a V shape, and the respective second conductor has a V shape.

In some embodiments, the respective radiating element of the plurality of radiating elements 100 further includes one or more first slots 105 extending through the one or more radiating oscillators 101 and the dielectric substrate 104. Optionally, a respective coupling balun of a plurality of coupling baluns 400 is connected to the respective radiating element through the one or more first slots 105.

In some embodiments, the plurality of radiating elements 100 are arranged along a first direction DR1, and the one or more conductors are arranged along a direction substantially parallel to a second direction DR2, the second direction DR2 is different from the first direction DR1, and the first direction DR1 and the second direction DR2 intersect each other. As used herein, the term “substantially parallel” means that an angle is in the range of 0 degree to approximately 45 degrees, e.g., 0 degree to approximately 5 degrees, 0 degree to approximately 10 degrees, 0 degree to approximately 15 degrees, 0 degree to approximately 20 degrees, 0 degree to approximately 25 degrees, 0 degree to approximately 30 degrees.

In some embodiments, the respective radiating element has a substantial mirror symmetry (e.g., at least 80% mirror symmetry, at least 85% mirror symmetry, at least 90% mirror symmetry, at least 95% mirror symmetry, at least 99% mirror symmetry, or 100% mirror symmetry) with respect to a first plane perpendicular to the dielectric substrate 104 and intersecting the one or more conductors. Optionally, the first plane is not intersecting with the one or more radiating oscillators 101.

In some embodiments, the plurality of radiating elements 100 are arranged along a first direction DR1, and the first plane is substantially parallel to a second direction DR2, the second direction DR2 is different from the first direction DR1, and the first direction DR1 and the second direction DR2 intersect each other.

In some embodiments, the respective radiating element has a substantial mirror symmetry (e.g., at least 80% mirror symmetry, at least 85% mirror symmetry, at least 90% mirror symmetry, at least 95% mirror symmetry, at least 99% mirror symmetry, or 100% mirror symmetry) with respect to a second plane perpendicular to the dielectric substrate 104 and substantially parallel to the first direction DR1. Optionally, the second plane is not intersecting with the one or more radiating oscillators 101, and is not intersecting with the one or more conductors.

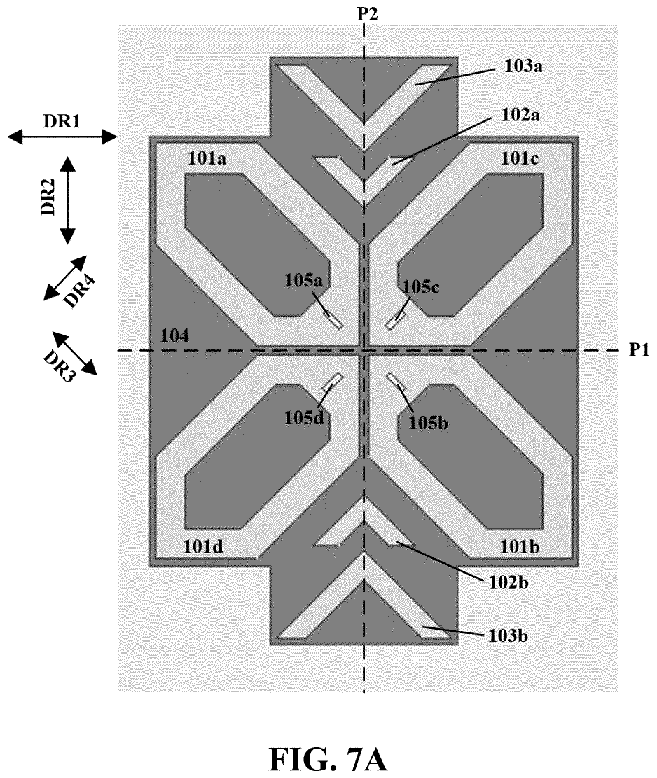

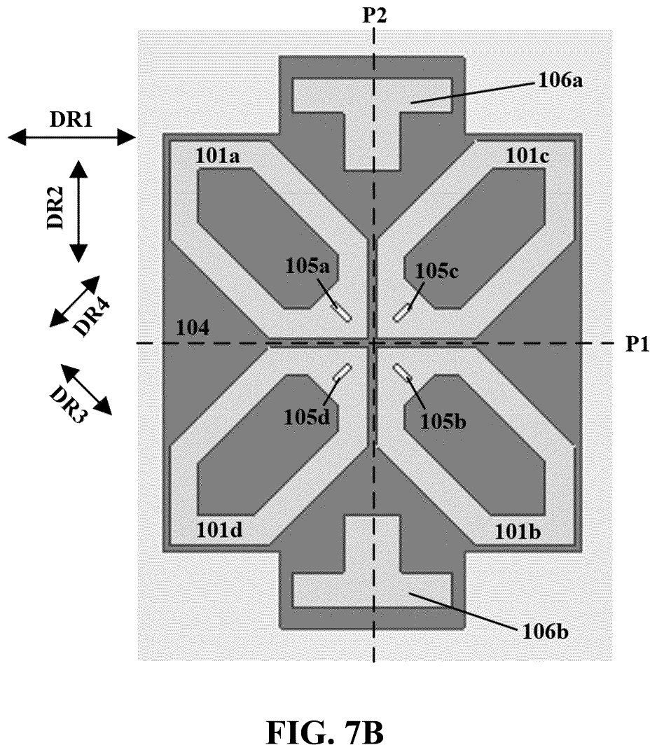

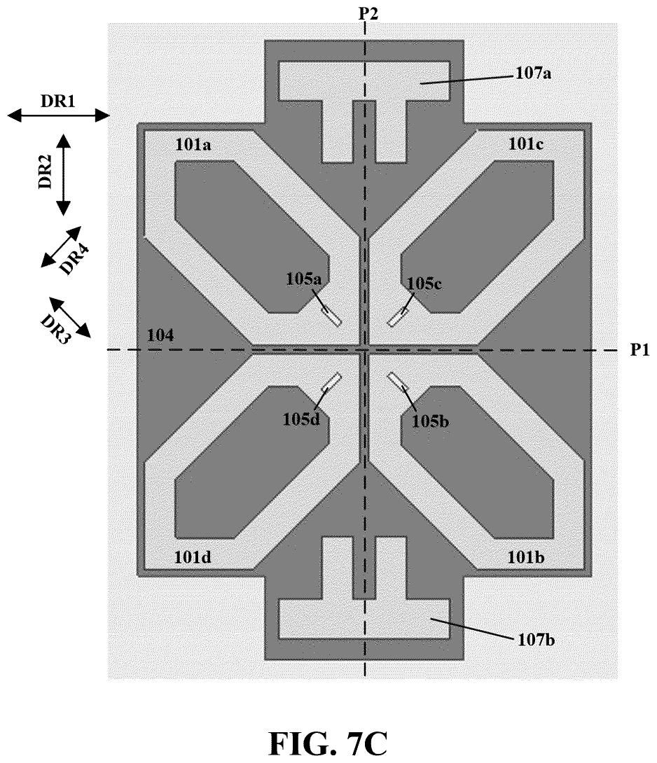

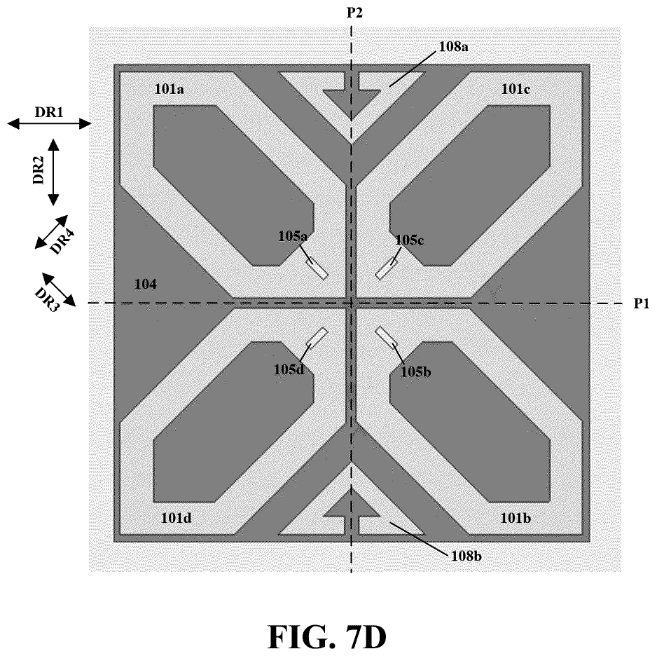

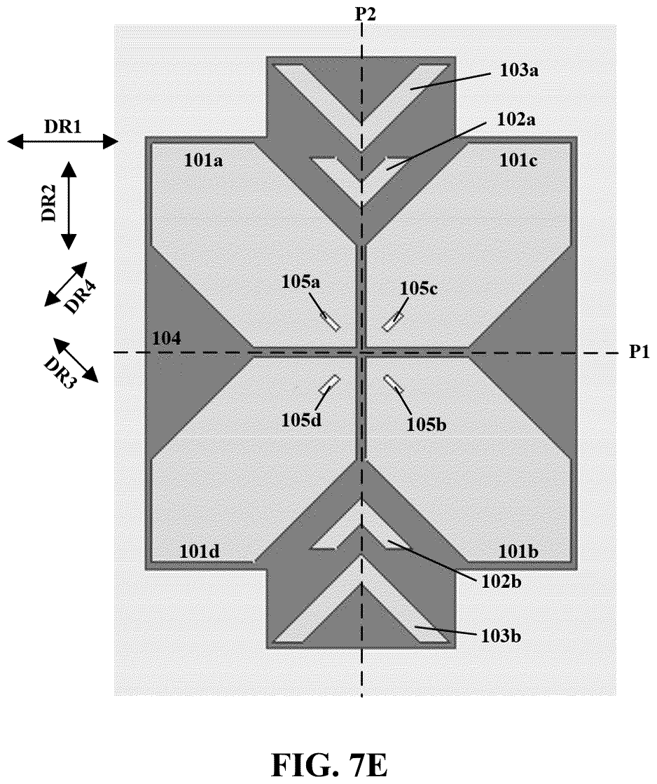

FIG. 7A is a schematic diagram illustrating the structure of a respective radiating element in some embodiments according to the present disclosure. Referring to FIG. 7A, in some embodiments, the respective radiating element includes four radiating oscillators (101a, 101b, 101c, 101d) spaced apart from each other. Optionally, the four radiating oscillators have a substantial mirror symmetry with respect to the first plane P1. Optionally, the four radiating oscillators have a substantial mirror symmetry with respect to the second plane P2. Referring to FIG. 7A, a plan view of the first plane P1 is denoted by a dotted line, a plan view of the second plane P2 is denoted by another dotted line.

In some embodiments, the respective radiating element includes two first conductors (102a and 102b) and two second conductors (103a and 103b). Optionally, a first one (103a) of the two second conductors, a first one (102a) of the two first conductors, a second one (102b) of the two first conductors, and a second one (103b) of the two second conductors are arranged along a direction substantially parallel to the second direction DR2.

In some embodiments, the respective radiating element includes four first slots (105a, 105b, 105c, 105d) spaced apart from each other. Optionally, the four first slots have a substantial mirror symmetry with respect to the first plane P1. Optionally, the four first slots have a substantial mirror symmetry with respect to the second plane P2.

In some embodiments, a first one (101a) of the four radiating oscillators, a first one (105a) of the four first slots, a second one (105b) of the four first slots, and a second one (101b) of the four radiating oscillators are sequentially arranged along a third direction DR3. The third direction DR3 is different from the first direction DR1 and different from the second direction DR2.

In some embodiments, a third one (101c) of the four radiating oscillators, a third one (105c) of the four first slots, a fourth one (105d) of the four first slots, and a fourth one (101d) of the four radiating oscillators are sequentially arranged along a fourth direction DR4. The fourth direction DR4 is different from the first direction DR1, different from the second direction DR2, and different from the third direction DR3.

Optionally, an included angle between the first direction DR1 and the second direction DR2 is in a range of 85 degrees to 95 degrees, an included angle between the third direction DR3 and the fourth direction DR4 is in a range of 85 degrees to 95 degrees, an included angle between the third direction DR3 and the first direction DR1 is in a range of 40 degrees to 50 degrees, and an included angle between the fourth direction DR4 and the first direction DR1 is in a range of 40 degrees to 50 degrees. In one particular example, an included angle between the first direction DR1 and the second direction DR2 is 90 degrees, an included angle between the third direction DR3 and the fourth direction DR4 is 90 degrees, an included angle between the third direction DR3 and the first direction DR1 is 45 degrees, and an included angle between the fourth direction DR4 and the first direction DR1 is 45 degrees.

In some embodiments, a maximum width of a respective conductor of the one or more conductors is in a range of 0.10 to 0.50 times (e.g., 0.10 to 0.15 times, 0.15 to 0.20 times, 0.20 to 0.25 times, 0.25 to 0.30 times, 0.30 to 0.35 times, 0.35 to 0.40 times, 0.40 to 0.45 times, or 0.45 to 0.50 times) of a wavelength of the electromagnetic waves that the antenna is designed to transmit or receive, e.g., an operating wavelength of the specific frequency at which the antenna is designed to operate. The wavelength may be calculated by: Wavelength (λ)=Speed of Light (c)/Frequency. Optionally, the maximum width of the respective conductor of the one or more conductors is in a range of 0.20 to 0.30 times of the wavelength of the electromagnetic waves that the antenna is designed to transmit or receive. In one example, the maximum width of the respective conductor of the one or more conductors is 0.25 times of the wavelength of the electromagnetic waves that the antenna is designed to transmit or receive.

In some embodiments, a maximum width of a respective first conductor of the two first conductors (102a and 102b) is in a range of 0.10 to 0.50 times (e.g., 0.10 to 0.15 times, 0.15 to 0.20 times, 0.20 to 0.25 times, 0.25 to 0.30 times, 0.30 to 0.35 times, 0.35 to 0.40 times, 0.40 to 0.45 times, or 0.45 to 0.50 times) of a first wavelength of the electromagnetic waves that the antenna is designed to transmit or receive; and a maximum width of a respective second conductor of the two second conductors (103a and 103b) is in a range of 0.10 to 0.50 times (e.g., 0.10 to 0.15 times, 0.15 to 0.20 times, 0.20 to 0.25 times, 0.25 to 0.30 times, 0.30 to 0.35 times, 0.35 to 0.40 times, 0.40 to 0.45 times, or 0.45 to 0.50 times) of a second wavelength of the electromagnetic waves that the antenna is designed to transmit or receive; the first wavelength is different from the second wavelength. Optionally, the first wavelength is smaller than the second wavelength. Optionally, the first wavelength is a wavelength of a high-frequency band of the electromagnetic waves that the antenna is designed to transmit or receive; and the second wavelength is a wavelength of a low-frequency band of the electromagnetic waves that the antenna is designed to transmit or receive. Optionally, the maximum width of the respective first conductor of the two first conductors (102a and 102b) is in a range of 0.20 to 0.30 times of the first wavelength of the electromagnetic waves that the antenna is designed to transmit or receive; and the maximum width of the respective second conductor of the two second conductors (103a and 103b) is in a range of 0.20 to 0.30 times of the second wavelength of the electromagnetic waves that the antenna is designed to transmit or receive. In one particular example, the maximum width of the respective first conductor of the two first conductors (102a and 102b) is 0.25 times of the first wavelength of the electromagnetic waves that the antenna is designed to transmit or receive; and the maximum width of the respective second conductor of the two second conductors (103a and 103b) is 0.25 times of the second wavelength of the electromagnetic waves that the antenna is designed to transmit or receive. In another particular example, the first wavelength corresponds to a frequency of 2.69 GHz, and the second wavelength corresponds to a frequency of 1.71 GHZ.

In some embodiments, the one or more conductors may include additional V-shaped conductors (other than 102a, 102b, 103a, and 103b) to further optimize polarization isolation of the antenna.

FIG. 7B is a schematic diagram illustrating the structure of a respective radiating element in some embodiments according to the present disclosure. Referring to FIG. 7B, in some embodiments, the respective radiating element has a substantial mirror symmetry (e.g., at least 80% mirror symmetry, at least 85% mirror symmetry, at least 90% mirror symmetry, at least 95% mirror symmetry, at least 99% mirror symmetry, or 100% mirror symmetry) with respect to a first plane P1 perpendicular to the dielectric substrate 104 and intersecting the one or more conductors. Optionally, the first plane P1 is not intersecting with the one or more radiating oscillators 101. In some embodiments, the plurality of radiating elements 100 are arranged along a first direction DR1, and the first plane P1 is substantially parallel to a second direction DR2, the second direction DR2 is different from the first direction DR1, and the first direction DR1 and the second direction DR2 intersect each other.

In some embodiments, the respective radiating element has a substantial mirror symmetry (e.g., at least 80% mirror symmetry, at least 85% mirror symmetry, at least 90% mirror symmetry, at least 95% mirror symmetry, at least 99% mirror symmetry, or 100% mirror symmetry) with respect to a second plane P2 perpendicular to the dielectric substrate 104 and substantially parallel to the first direction DR1. Optionally, the second plane P2 is not intersecting with the one or more radiating oscillators 101, and is not intersecting with the one or more conductors.

Referring to FIG. 7B, in some embodiments, the respective radiating element includes four radiating oscillators (101a, 101b, 101c, 101d) spaced apart from each other. Optionally, the four radiating oscillators have a substantial mirror symmetry with respect to the first plane P1. Optionally, the four radiating oscillators have a substantial mirror symmetry with respect to the second plane P2. Referring to FIG. 7B, a plan view of the first plane P1 is denoted by a dotted line, a plan view of the second plane P2 is denoted by another dotted line.

In some embodiments, the respective radiating element includes four first slots (105a, 105b, 105c, 105d) spaced apart from each other. Optionally, the four first slots have a substantial mirror symmetry with respect to the first plane P1. Optionally, the four first slots have a substantial mirror symmetry with respect to the second plane P2.

In some embodiments, a first one (101a) of the four radiating oscillators, a first one (105a) of the four first slots, a second one (105b) of the four first slots, and a second one (101b) of the four radiating oscillators are arranged along a third direction DR3. The third direction DR3 is different from the first direction DR1 and different from the second direction DR2.

In some embodiments, a third one (101c) of the four radiating oscillators, a third one (105c) of the four first slots, a fourth one (105d) of the four first slots, and a fourth one (101d) of the four radiating oscillators are arranged along a fourth direction DR4. The fourth direction DR4 is different from the first direction DR1, different from the second direction DR2, and different from the third direction DR3.

In some embodiments, the respective radiating element includes two third conductors (106a and 106b). Optionally, a first one (106a) of the two third conductors and a second one (106b) of the two third conductors are arranged along a direction substantially parallel to the second direction DR2.

In some embodiments, a respective third conductor of the two third conductors has a T shape. The T shape includes an arm portion and a stem portion intersecting with the arm portion. The stem portion buts against the arm portion, and extends away from the arm portion. Optionally, the arm portion is on a side of the stem portion away from a center of the respective radiating element.

FIG. 7C is a schematic diagram illustrating the structure of a respective radiating element in some embodiments according to the present disclosure. Referring to FIG. 7C, in some embodiments, the respective radiating element has a substantial mirror symmetry (e.g., at least 80% mirror symmetry, at least 85% mirror symmetry, at least 90% mirror symmetry, at least 95% mirror symmetry, at least 99% mirror symmetry, or 100% mirror symmetry) with respect to a first plane P1 perpendicular to the dielectric substrate 104 and intersecting the one or more conductors. Optionally, the first plane P1 is not intersecting with the one or more radiating oscillators 101. In some embodiments, the plurality of radiating elements 100 are arranged along a first direction DR1, and the first plane P1 is substantially parallel to a second direction DR2, the second direction DR2 is different from the first direction DR1, and the first direction DR1 and the second direction DR2 intersect each other.

In some embodiments, the respective radiating element has a substantial mirror symmetry (e.g., at least 80% mirror symmetry, at least 85% mirror symmetry, at least 90% mirror symmetry, at least 95% mirror symmetry, at least 99% mirror symmetry, or 100% mirror symmetry) with respect to a second plane P2 perpendicular to the dielectric substrate 104 and substantially parallel to the first direction DR1. Optionally, the second plane P2 is not intersecting with the one or more radiating oscillators 101, and is not intersecting with the one or more conductors.

Referring to FIG. 7C, in some embodiments, the respective radiating element includes four radiating oscillators (101a, 101b, 101c, 101d) spaced apart from each other. Optionally, the four radiating oscillators have a substantial mirror symmetry with respect to the first plane P1. Optionally, the four radiating oscillators have a substantial mirror symmetry with respect to the second plane P2. Referring to FIG. 7C, a plan view of the first plane P1 is denoted by a dotted line, a plan view of the second plane P2 is denoted by another dotted line.

In some embodiments, the respective radiating element includes four first slots (105a, 105b, 105c, 105d) spaced apart from each other. Optionally, the four first slots have a substantial mirror symmetry with respect to the first plane P1. Optionally, the four first slots have a substantial mirror symmetry with respect to the second plane P2.

In some embodiments, a first one (101a) of the four radiating oscillators, a first one (105a) of the four first slots, a second one (105b) of the four first slots, and a second one (101b) of the four radiating oscillators are arranged along a third direction DR3. The third direction DR3 is different from the first direction DR1 and different from the second direction DR2.

In some embodiments, a third one (101c) of the four radiating oscillators, a third one (105c) of the four first slots, a fourth one (105d) of the four first slots, and a fourth one (101d) of the four radiating oscillators are arranged along a fourth direction DR4. The fourth direction DR4 is different from the first direction DR1, different from the second direction DR2, and different from the third direction DR3.

In some embodiments, the respective radiating element includes two fourth conductors (107a and 107b). Optionally, a first one (107a) of the two fourth conductors and a second one (107b) of the two fourth conductors are arranged along a direction substantially parallel to the second direction DR2.

In some embodiments, a respective fourth conductor of the two fourth conductors has a π shape. The π shape includes an arm portion, a first stem portion intersecting with the arm portion, and a second stem portion intersecting with the arm portion. The first stem portion buts against the arm portion, and extends away from the arm portion. The second stem portion buts against the arm portion, and extends away from the arm portion. Optionally, the arm portion is on a side of the first stem portion and the second stem portion away from a center of the respective radiating element.

FIG. 7D is a schematic diagram illustrating the structure of a respective radiating element in some embodiments according to the present disclosure. Referring to FIG. 7D, in some embodiments, the respective radiating element has a substantial mirror symmetry (e.g., at least 80% mirror symmetry, at least 85% mirror symmetry, at least 90% mirror symmetry, at least 95% mirror symmetry, at least 99% mirror symmetry, or 100% mirror symmetry) with respect to a first plane P1 perpendicular to the dielectric substrate 104 and intersecting the one or more conductors. Optionally, the first plane P1 is not intersecting with the one or more radiating oscillators 101. In some embodiments, the plurality of radiating elements 100 are arranged along a first direction DR1, and the first plane P1 is substantially parallel to a second direction DR2, the second direction DR2 is different from the first direction DR1, and the first direction DR1 and the second direction DR2 intersect each other.

In some embodiments, the respective radiating element has a substantial mirror symmetry (e.g., at least 80% mirror symmetry, at least 85% mirror symmetry, at least 90% mirror symmetry, at least 95% mirror symmetry, at least 99% mirror symmetry, or 100% mirror symmetry) with respect to a second plane P2 perpendicular to the dielectric substrate 104 and substantially parallel to the first direction DR1. Optionally, the second plane P2 is not intersecting with the one or more radiating oscillators 101, and is not intersecting with the one or more conductors.

Referring to FIG. 7D, in some embodiments, the respective radiating element includes four radiating oscillators (101a, 101b, 101c, 101d) spaced apart from each other. Optionally, the four radiating oscillators have a substantial mirror symmetry with respect to the first plane P1. Optionally, the four radiating oscillators have a substantial mirror symmetry with respect to the second plane P2. Referring to FIG. 7D, a plan view of the first plane P1 is denoted by a dotted line, a plan view of the second plane P2 is denoted by another dotted line.

In some embodiments, the respective radiating element includes four first slots (105a, 105b, 105c, 105d) spaced apart from each other. Optionally, the four first slots have a substantial mirror symmetry with respect to the first plane P1. Optionally, the four first slots have a substantial mirror symmetry with respect to the second plane P2.

In some embodiments, a first one (101a) of the four radiating oscillators, a first one (105a) of the four first slots, a second one (105b) of the four first slots, and a second one (101b) of the four radiating oscillators are arranged along a third direction DR3. The third direction DR3 is different from the first direction DR1 and different from the second direction DR2.

In some embodiments, a third one (101c) of the four radiating oscillators, a third one (105c) of the four first slots, a fourth one (105d) of the four first slots, and a fourth one (101d) of the four radiating oscillators are arranged along a fourth direction DR4. The fourth direction DR4 is different from the first direction DR1, different from the second direction DR2, and different from the third direction DR3.

In some embodiments, the respective radiating element includes two fifth conductors (108a and 108b). Optionally, a first one (108a) of the two fifth conductors and a second one (108b) of the two fifth conductors are arranged along a direction substantially parallel to the second direction DR2.

In some embodiments, a respective fifth conductor of the two fifth conductors has an open triangular ring shape. The open triangular ring shape includes a side portion that is open, and a vertex opposite to the side portion that is open. Optionally, the side portion that is open is on a side of the vertex opposite to the side portion that is open away from a center of the respective radiating element. Optionally, the open triangular ring shape further include two side portions that are not open. The two side portions that are not open connect the vertex opposite to the side portion that is open with the side portion that is open, respectively.

Referring to FIG. 1 to FIG. 6, FIG. 7A to FIG. 7D, in some embodiments, the respective radiating oscillator has a ring shape, e.g., the respective radiating oscillator is a ring-shaped radiating oscillator. The inventors of the present disclosure discover that, by having a ring-shaped radiating oscillator, the antenna's adjustable parameters may be increased. For example, by adding adjustable parameters to the internal aperture of the ring structure, the overall antenna performance can be further optimized by adjusting their corresponding dimensions, making it more conducive to the design flexibility of the antenna.

In some embodiments, an outer periphery of the ring-shaped radiating oscillator has a hexagonal shape, and an inner periphery of the ring-shaped radiating oscillator has a heptagonal shape. Optionally, four vertices of four ring-shaped radiating oscillators surround a center of the respective radiating element.

FIG. 7E is a schematic diagram illustrating the structure of a respective radiating element in some embodiments according to the present disclosure. Referring to FIG. 7E, the respective radiating oscillator has polygonal shape. In one particular example depicted in FIG. 7E, an outer periphery of the polygonal-shaped radiating oscillator has a hexagonal shape. Optionally, four vertices of four radiating oscillators surround a center of the respective radiating element.

In some embodiments, the plurality of radiating elements 100 are arranged in a linear array. Optionally, the plurality of radiating elements 100 are spaced apart from each other by a distance in a range of 75 mm to 125 mm, e.g., 75 mm to 80 mm, 80 mm to 85 mm, 85 mm to 90 mm, 90 mm to 95 mm, 95 mm to 100 mm, 100 mm to 105 mm, 105 mm to 110 mm, 110 mm to 115 mm, 115 mm to 120 mm, or 120 mm to 125 mm. As shown in FIG. 6, in some embodiments, the plurality of radiating elements includes a first radiating element 100a, a second radiating element 100b, a third radiating element 100c, and a fourth radiating element 100d, arranged in a linear array.

In some embodiments, the dielectric substrate 104 is a printed circuit board base substrate. Optionally, the one or more radiating oscillators 101 and the one or more conductors are printed on the printed circuit board base substrate. In one example, the dielectric substrate 104 has a thickness of 1 mm. In another example, the dielectric substrate 104 includes an FR4 material having a dielectric constant of 4.4.

Referring to FIG. 1 to FIG. 6, the antenna in some embodiments further includes a plurality of coupling baluns 400. Optionally, the plurality of coupling baluns 400 includes a first coupling balun 400a, a second coupling balun 400b, a third coupling balun 400c, and a fourth coupling balun 400d, arranged in a linear array. In some embodiments, the antenna further includes a first reflector 600. The plurality of coupling baluns 400 is on the first reflector 600, and the plurality of radiating elements 100 is on a side of the plurality of coupling baluns 400 away from the first reflector 600.

In some embodiments, a respective coupling balun of the plurality of coupling baluns 400 includes a first feeding balun 410 and a second feeding balun 420. Optionally, the first feeding balun 410 and the second feeding balun 420 intersect each other. In some embodiments, in a cross-section along a plane intersecting the plurality of coupling baluns 400 and parallel to surfaces of the plurality of radiating elements 100, the respective coupling balun has a X shape. In some embodiments, an included angle between the first feeding balun 410 and the second feeding balun 420 is in a range of 75 degrees to 115 degrees, e.g., 75 degrees to 80 degrees, 80 degrees to 85 degrees, 85 degrees to 90 degrees, 90 degrees to 95 degrees, 95 degrees to 100 degrees, 100 degrees to 105 degrees, 105 degrees to 110 degrees, or 110 degrees to 115 degrees. Optionally, the included angle between the first feeding balun 410 and the second feeding balun 420 is in a range of 85 degrees to 95 degrees. In one particular example, the included angle between the first feeding balun 410 and the second feeding balun 420 is 90 degrees.

In some embodiments, in the cross-section along the plane intersecting the plurality of coupling baluns 400 and parallel to the surfaces of the plurality of radiating elements 100, the first feeding balun 410 extends along a direction substantially parallel to the third direction DR3, and the second feeding balun 420 extends along a direction substantially parallel to the fourth direction DR4.

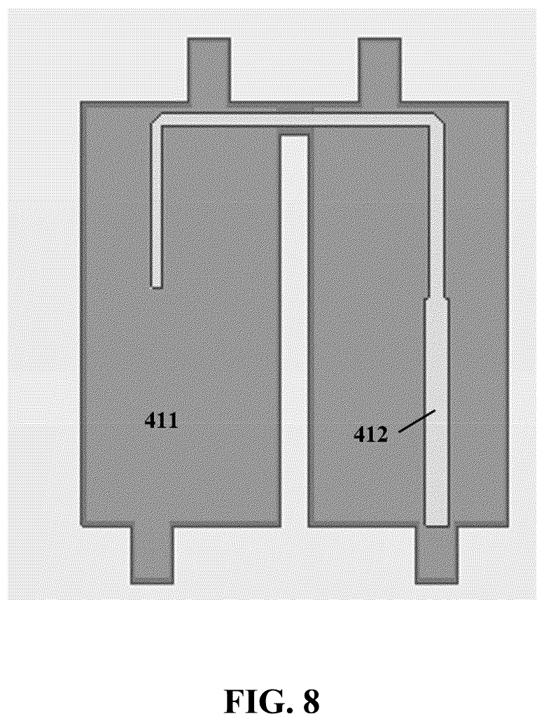

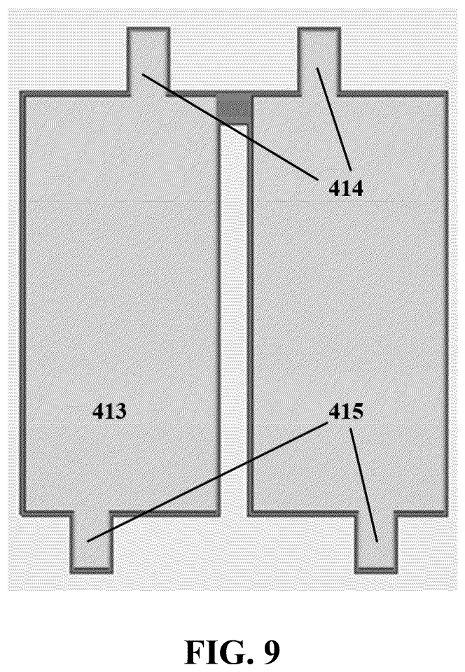

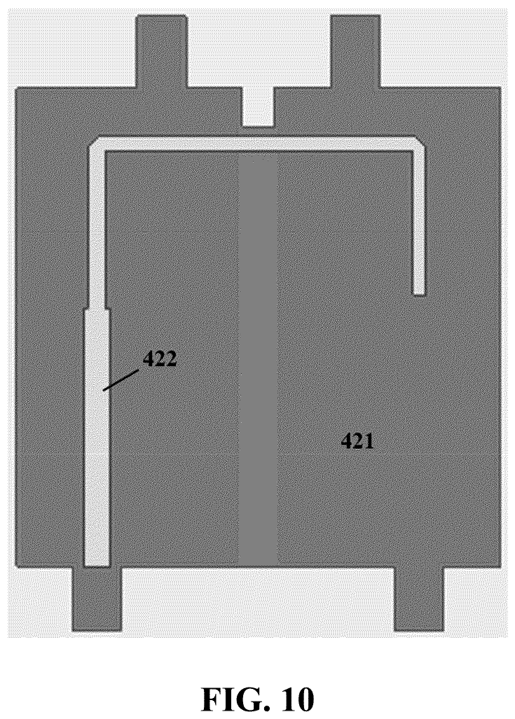

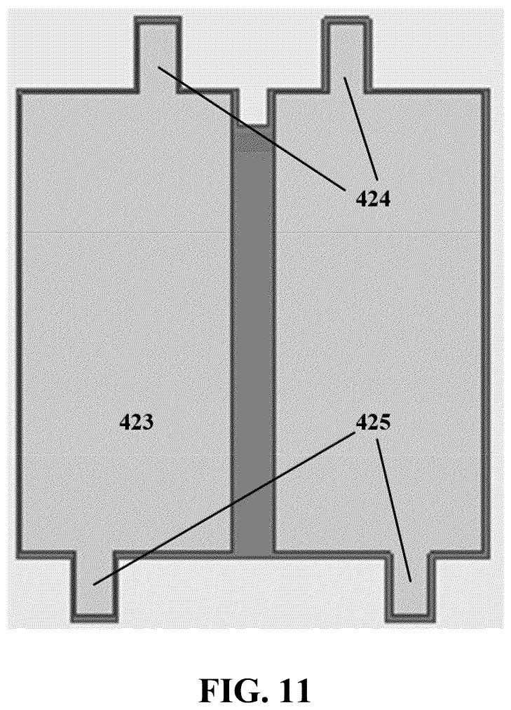

FIG. 8 is a plan view of a first side of a first feeding balun in some embodiments according to the present disclosure. FIG. 9 is a plan view of a second side of a first feeding balun in some embodiments according to the present disclosure. FIG. 10 is a plan view of a first side of a second feeding balun in some embodiments according to the present disclosure. FIG. 11 is a plan view of a second side of a second feeding balun in some embodiments according to the present disclosure. Referring to FIG. 8 to FIG. 11, the first feeding balun 410 in some embodiments includes a first dielectric substrate 411, a first balun trace 412, and a first ground 413. Optionally, the first balun trace 412 and the first ground 413 are spaced apart by the first dielectric substrate 411, and the first balun trace 412 and the first ground 413 are on two opposite sides of the first dielectric substrate 411 along a thickness direction of the first dielectric substrate 411.

Referring to FIG. 8 to FIG. 11, the second feeding balun 420 in some embodiments includes a second dielectric substrate 421, a second balun trace 422, and a second ground 423. Optionally, the second balun trace 422 and a second ground 423 are spaced apart by the second dielectric substrate 421, and the second balun trace 422 and a second ground 423 are on two opposite sides of the second dielectric substrate 421 along a thickness direction of the second dielectric substrate 421.

In some embodiments, the first ground 413 includes one or more first solder pads 414 connected to the respective radiating element. Optionally, the one or more first solder pads 414 are connected to the one or more radiating oscillators 101.

In some embodiments, the second ground 423 includes one or more second solder pads 424 connected to the respective radiating element. Optionally, the one or more second solder pads 424 are connected to the one or more radiating oscillators 101.

In some embodiments, the one or more first solder pads 414 and the one or more second solder pads 424 are inserted into the one or more first slots 105 extending through the one or more radiating oscillators 101. In some embodiments, the first one (101a) of the four radiating oscillators, the one or more first solder pads 414, and the second one (101b) of the four radiating oscillators are sequentially arranged along the third direction DR3. In some embodiments, the third one (101c) of the four radiating oscillators, the one or more second solder pads 424, and the fourth one (101d) of the four radiating oscillators are sequentially arranged along the fourth direction DR4.

In some embodiments, the first ground 413 further includes one or more third solder pads 415. In some embodiments, the antenna further includes a first power divider network 200. Optionally, the one or more third solder pads 415 are connected to one or more grounds.

In some embodiments, the second ground 423 further includes one or more fourth solder pads 425. Optionally, the one or more fourth solder pads 425 are connected to one or more grounds.

In some embodiments, the antenna further includes a first power divider network 200 configured to provide feeding to the plurality of radiating elements 100. Optionally, the first power divider network 200 is connected to the plurality of coupling baluns 400, and the plurality of coupling baluns 400 are connected to the plurality of radiating elements 100. The first power divider network 200 is configured to provide feeding to the plurality of coupling baluns 400, and the plurality of coupling baluns 400 are configured to provide feeding to the plurality of radiating elements 100.

In some embodiments, the first power divider network 200 includes a first power divider sub-network 210 and a second power divider sub-network 220. The first power divider sub-network 210 is configured to provide feeding to a first group of coupling baluns (e.g., 400a and 400b) of the plurality of coupling baluns 400, and the second power divider sub-network 220 is configured to provide feeding to a second group of coupling baluns (e.g., 400c and 400d) of the plurality of coupling baluns 400.

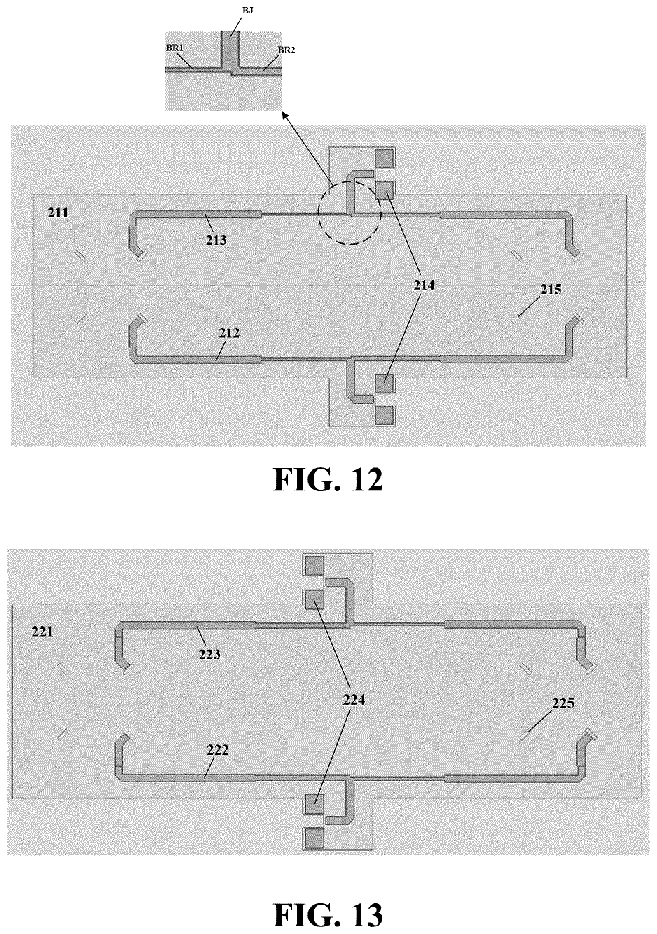

FIG. 12 is a schematic diagram illustrating the structure of a first power divider sub-network in some embodiments according to the present disclosure. FIG. 13 is a schematic diagram illustrating the structure of a second power divider sub-network in some embodiments according to the present disclosure. As shown in FIG. 12 and FIG. 13, in some embodiments, the first power divider network 200 utilizes unequal power division (as shown in the zoom-in view of the dotted circle in FIG. 12). The bus junction BJ branches into a first branch line BR1 and a second branch line BR2. The first branch line BR1 and the second branch line BR2 in some embodiments have different width and/or thickness, thereby achieving optimized sidelobe levels of the antenna.

In some embodiments, the first power divider sub-network 210 includes a third dielectric substrate 211, one or more first power divider traces (e.g., 212 and 213), and one or more third solder pads 214. In some embodiments, the second power divider sub-network 220 includes a fourth dielectric substrate 221, one or more second power divider traces (e.g., 222 and 223), and one or more fourth solder pads 224. Optionally, the third dielectric substrate 211 and the fourth dielectric substrate 221 are printed circuit board base substrates. In one particular example, the third dielectric substrate 211 and the fourth dielectric substrate 221 include a RO4350B material. RO4350B is a high-frequency circuit material used in the field of electronics and radio frequency (RF) applications. It is a type of thermoset-based, woven glass-reinforced hydrocarbon laminate with a ceramic filler, designed for high-performance printed circuit boards (PCBs). RO4350B is manufactured by Rogers Corporation. In one example, the third dielectric substrate 211 and the fourth dielectric substrate 221 have a thickness of 0.762 mm.

In some embodiments, at least one (e.g., 212) of the one or more first power divider traces is connected to the first balun trace 412 of a corresponding first feeding balun (e.g., 410). In some embodiments, at least one (e.g., 222) of the one or more second power divider traces are connected to the first balun trace 412 of a corresponding first feeding balun (e.g., 410). In some embodiments, at least another (e.g., 213) of the one or more first power divider traces is connected to the second balun trace 422 of a corresponding second feeding balun (e.g., 420).

In some embodiments, at least another (e.g., 223) of the one or more second power divider traces are connected to the second balun trace 422 of a corresponding second feeding balun (e.g., 420).

In some embodiments, referring to FIG. 1 to FIG. 6, the antenna further includes one or more coaxial lines 901 configured to provide ground for the antenna. Referring to FIG. 1 to FIG. 6, FIG. 12, and FIG. 13, in some embodiments, the one or more third solder pads 214 and the one or more fourth solder pads 224 are connected to the one or more coaxial lines 901. In one example, a respective solder pad of the one or more third solder pads 214 and the one or more fourth solder pads 224 is soldered to an outer periphery of a respective coaxial line of the one or more coaxial lines 901.

In some embodiments, the first power divider sub-network 210 includes one or more second slots 215, and the second power divider sub-network 220 includes one or more third slots 225. The one or more second slots 215 and the one or more third slots 225 are configured to receive the one or more third solder pads 415 and the one or more fourth solder pads 425.

The one or more third solder pads 415 and the one or more fourth solder pads 425 extend through the one or more second slots 215 or the one or more third slots 225, and are soldered to ground pads on a backside of the first power divider network 200.

In some embodiments, the antenna further includes a second power divider network 300 configured to connect the first power divider sub-network 210 with the second power divider sub-network 220. Referring to FIG. 1 to FIG. 6, in some embodiments, the second power divider network 300 is connected to a first coaxial line, and the first coaxial line is connected to the first power divider sub-network 210; the second power divider network 300 is connected to a second coaxial line, and the second coaxial line is connected to the second power divider sub-network 220. The inventors of the present disclosure discover that this structure effectively reduces the losses caused by microstrip traces, thereby enhancing the antenna's gain.

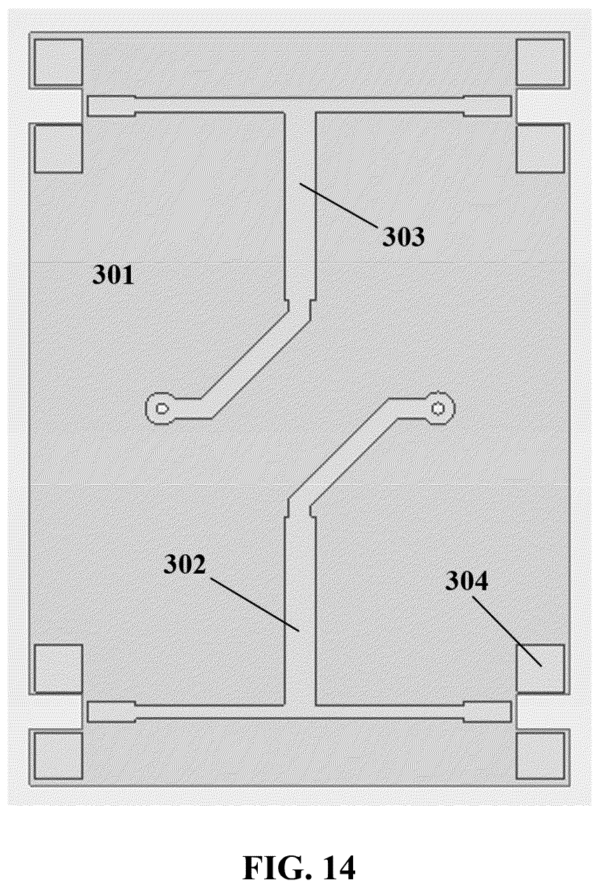

FIG. 14 is a schematic diagram illustrating the structure of a second power divider network in some embodiments according to the present disclosure. Referring to FIG. 14, the second power divider network in some embodiments includes a fifth dielectric substrate 301, one or more third power divider traces (e.g., 302 and 303), and one or more fifth solder pads 304. Optionally, the fifth dielectric substrate 301 is a printed circuit board base substrate. In one particular example, the fifth dielectric substrate 301 includes a RO4350B material. In one example, the power divider trace 302 is connected to the power divider traces 212 and 222; and the power divider trace 303 is connected to the power divider traces 213 and 223. In some embodiments, the one or more fifth solder pads 304 are connected to a respective coaxial line of the one or more coaxial lines 901. In one example, a respective solder pad of the one or more fifth solder pads 304 is soldered to an outer periphery of the respective coaxial line of the one or more coaxial lines 901.

In some embodiments, referring to FIG. 1 to FIG. 6, the antenna further includes one or more isolators 500. Optionally, a respective isolator of the one or more isolators 500 spaces apart two adjacent radiating elements in a same group of radiating elements. In some embodiments, the antenna includes a first group of radiating elements and a second group of radiating elements. Optionally, the first group of radiating elements includes a first radiating element 100a and a second radiating element 100b; and the second group of radiating elements includes a third radiating element 100c and a fourth radiating element 100d. Optionally, the one or more isolators 500 includes a first isolator spacing apart the first radiating element 100a and the second radiating element 100b, and a second isolator spacing apart the third radiating element 100c and the fourth radiating element 100d. Optionally, the antenna is absent of isolators between two adjacent groups of radiating elements. For example, the antenna is absent of isolators between the second radiating element 100b and the third radiating element 100c. The inventors of the present disclosure discover that the one or more isolators 500 effectively enhance the port isolation of the antenna.

In some embodiments, a respective isolator of the one or more isolators 500 includes an isolation strip 501 and one or more supports 502 configured to support the isolation strip 501. The isolation strip 501 is on a side of the one or more supports 502 away from the first power divider network 200. Optionally, the isolation strip 501 and the plurality of radiating elements 100 have a substantially same height relative to the first power divider network 200. Optionally, the respective isolator further includes one or more nuts configured to attach the isolation strip 501 to the one or more supports 502.

In some embodiments, a length of the isolation strip 501 is in a range of 0.10 to 1.0 times (e.g., 0.10 to 0.20 times, 0.20 to 0.30 times, 0.30 to 0.40 times, 0.40 to 0.50 times, 0.50 to 0.60 times, 0.60 to 0.70 times, 0.70 to 0.80 times, 0.80 to 0.90 times, or 0.90 to 1.0 times) of a wavelength of the electromagnetic waves that the antenna is designed to transmit or receive. Optionally, the length of the isolation strip 501 is in a range of 0.50 to 0.65 times of the wavelength of the electromagnetic waves that the antenna is designed to transmit or receive. In one example, the length of the isolation strip 501 is 0.60 times of the wavelength of the electromagnetic waves that the antenna is designed to transmit or receive. In another particular example, the wavelength corresponds to a frequency of 1.8 GHz.

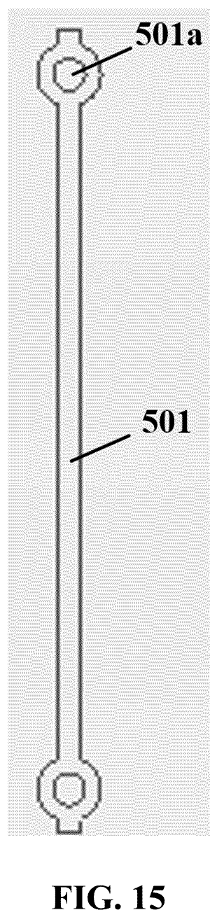

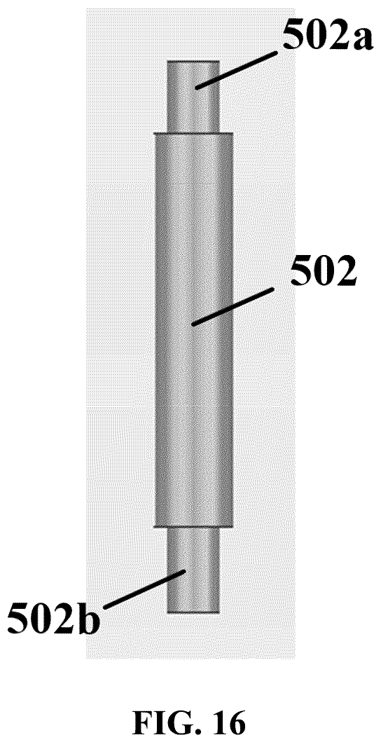

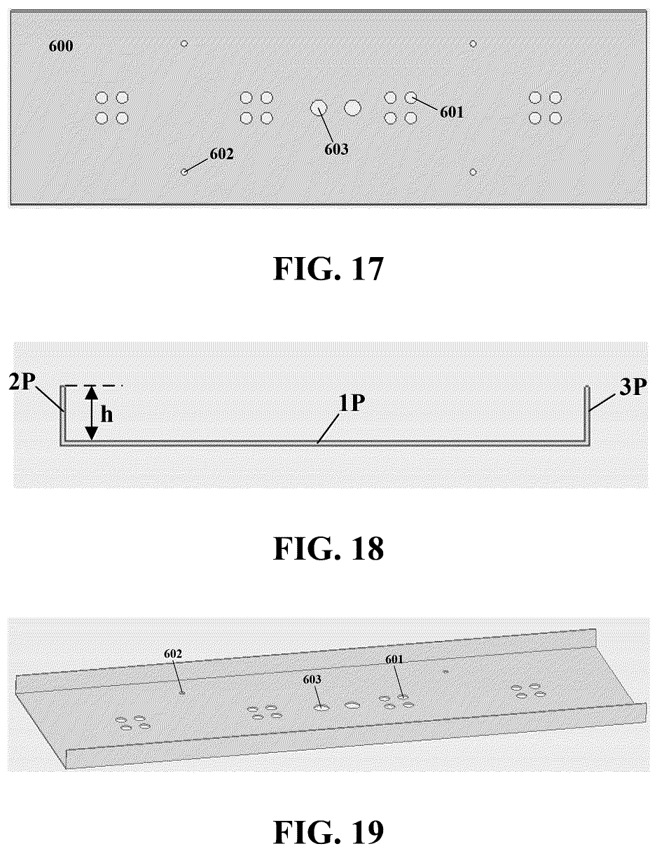

FIG. 15 is a schematic diagram illustrating the structure of an isolation strip in some embodiments according to the present disclosure. FIG. 16 is a plan view of a support in some embodiments according to the present disclosure. FIG. 17 is a plan view of a first reflector in some embodiments according to the present disclosure. FIG. 18 is a cross-sectional view of a first reflector in some embodiments according to the present disclosure. FIG. 19 is a perspective view of a first reflector in some embodiments according to the present disclosure. In some embodiments, the isolation strip 501 includes one or more first openings 501a; the respective support includes a first end 502a and a second end 502b; and the first reflector 600 includes one or more second openings 602. The first end 502a of the respective support is inserted into a respective first opening of the one or more first openings 501a. The second end 502b of the respective support is inserted into a respective second opening of the one or more second openings 602, thereby attaching the isolation strip 501 to the one or more supports 502.

In some embodiments, the first reflector 600 is on a side of the first power divider network and the second power divider network away from the plurality of radiating elements 100. In some embodiments, a cross-section of the first reflector 600 along a plane substantially parallel to the second direction DR2 and perpendicular to surfaces of the plurality of radiating elements has a U shape. Referring to FIG. 18, the first reflector 600 in some embodiments includes a first portion 1P, a second portion 2P, and a third portion 3P. The first portion 1P is connected to the second portion 2P, and is connected to the third portion 3P. Optionally, an included angle between the first portion 1P and the second portion 2P is in a range of 85 degrees to 95 degrees, and an included angle between the first portion 1P and the third portion 3P is in a range of 85 degrees to 95 degrees. Optionally, the second portion 2P and the third portion 3P extend along a direction substantially parallel to the first direction DR1.

The inventors of the present disclosure discover that this structure allows for the optimization of the array's vertical plane beamwidth by adjusting the height of the U-shaped sidewalls (e.g., the second portion 2P and the third portion 3P) without increasing the overall width of the antenna. In some embodiments, the second portion 2P and the third portion 3P have a height h relative to the first portion 1P. Optionally, the height h is in a range of 0.05 to 0.15 times (e.g., 0.05 to 0.06 times, 0.06 to 0.07 times, 0.07 to 0.08 times, 0.08 to 0.09 times, 0.09 to 0.10 times, 0.10 to 0.11 times, 0.11 to 0.12 times, 0.12 to 0.13 times, 0.13 to 0.14 times, or 0.14 to 0.15 times) of a wavelength of the electromagnetic waves that the antenna is designed to transmit or receive. In one example, the height h is 0.1 times of the wavelength of the electromagnetic waves that the antenna is designed to transmit or receive.

Various appropriate materials may be used for making the first reflector 600. For example, the first reflector 600 may be made of various appropriate metallic materials. In one example, the first reflector 600 is made of a sheet metal. In another example, the sheet metal for making the first reflector 600 has a thickness of 1 mm.

In some embodiments, referring to FIG. 1 to FIG. 19, the antenna further includes one or more third openings 601 extending through the first reflector 600. Optionally, the one or more third solder pads 415 of the first feeding balun and the one or more fourth solder pads 425 of the second feeding balun extend through the one or more third openings 601.

In some embodiments, the antenna further includes one or more fourth openings 603 extending through the first reflector 600, and one or more radiofrequency traces 902 extending through the one or more fourth openings 603.

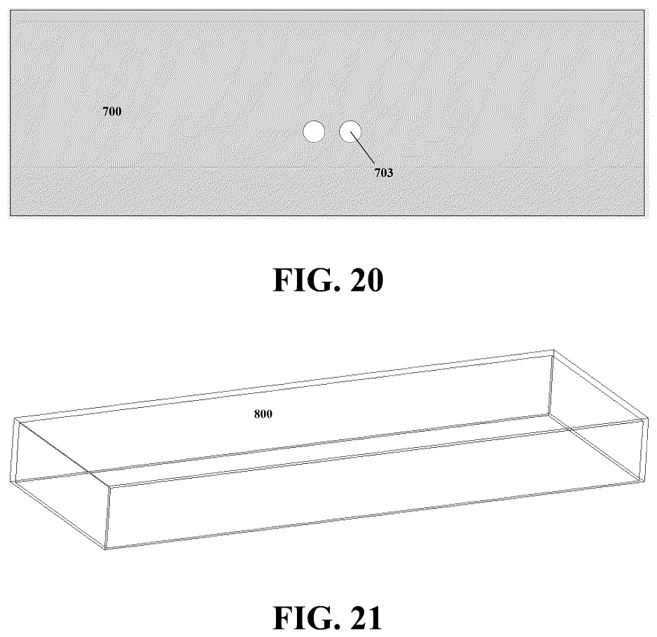

FIG. 20 is a plan view of a second reflector in some embodiments according to the present disclosure. Referring to FIG. 1 to FIG. 20, the antenna in some embodiments further includes a second reflector 700 on a side of the first reflector 600 away from the plurality of radiating elements 100. The antenna in some embodiments further includes one or more fifth openings 703 extending through the second reflector 700. The one or more radiofrequency traces 902 extend through the one or more fourth openings 603 and the one or more fifth openings 703. The inventors of the present disclosure discover that, by having the second reflector 700, the antenna's front-to-back ratio performance can be significantly improved.

Various appropriate materials may be used for making the second reflector 700. For example, the second reflector 700 may be made of various appropriate metallic materials. In one example, the second reflector 700 is made of a sheet metal. In another example, the sheet metal for making the second reflector 700 has a thickness of 1 mm.

FIG. 21 is a perspective view of a casing in some embodiments according to the present disclosure. Referring to FIG. 1 to FIG. 21, the antenna in some embodiments further includes a casing 800. The casing 800 and the second reflector 700 are configured to enclose the plurality of radiating elements 100, the plurality of coupling baluns 400, the first power divider network 200, the second power divider network 300, and the first reflector 600. Various appropriate materials may be used for making the casing 800. For example, the casing 800 may be made of a polycarbonate material having a dielectric constant of 2.9. In one example, the casing 800 is made of a polycarbonate material having a thickness of 3 mm.

The inventors of the present disclosure discover that the antenna according to the present disclosure achieves an exceptional performance with a wide bandwidth, e.g., in a range of 1710 MHz to 2690 MHz. The antenna according to the present disclosure has a low profile, a high degree of isolation, a high cross-polarization ratio, a high front-to-back ratio, and a high gain.

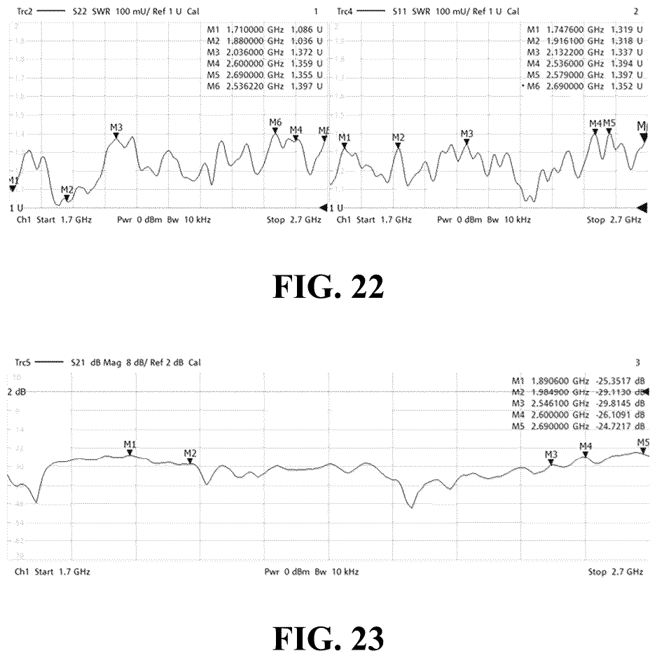

FIG. 22 is a graph showing voltage standing wave ratio values of an antenna in some embodiments according to the present disclosure. Referring to FIG. 22, the voltage standing wave ratio values of the antenna according to the present disclosure are consistently below 1.4 in the frequency range of 1710 to 2690 MHz.

FIG. 23 is a graph showing S21 parameters of an antenna in some embodiments according to the present disclosure. Referring to FIG. 23, the S21 parameters of the antenna according to the present disclosure are consistently below −24.5 dB in the frequency range of 1710 to 2690 MHZ.

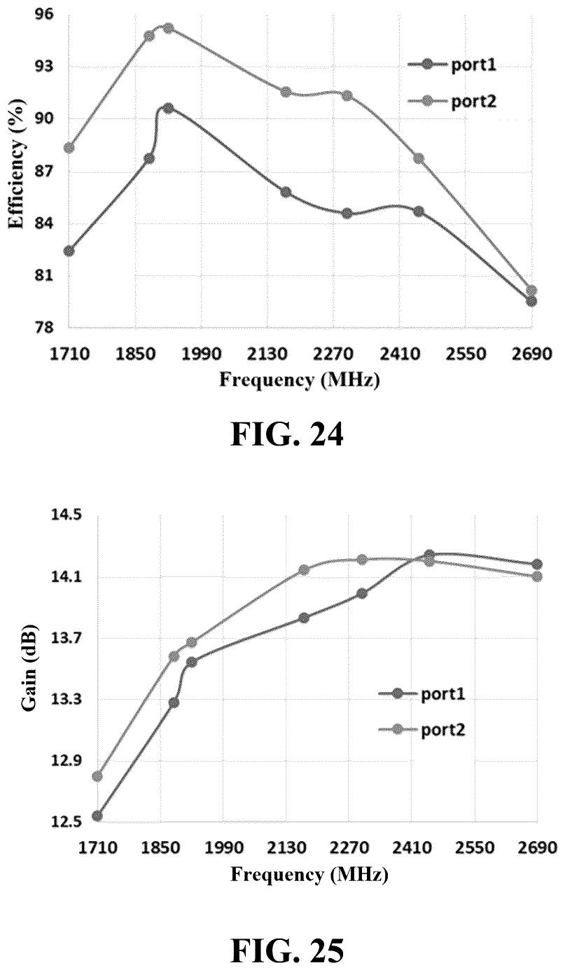

FIG. 24 is a graph showing efficiency values of an antenna in some embodiments according to the present disclosure. Referring to FIG. 24, the efficiency values in the frequency range of 1710 to 2690 MHz is in a range of 79.5% to 95.2%, with a slight decline in efficiency at higher frequencies.

FIG. 25 is a graph showing gain values of an antenna in some embodiments according to the present disclosure. Referring to FIG. 25, the gain values of the antenna according to the present disclosure are consistently higher than 12.5 dB in the frequency range of 1710 to 2690MHz.

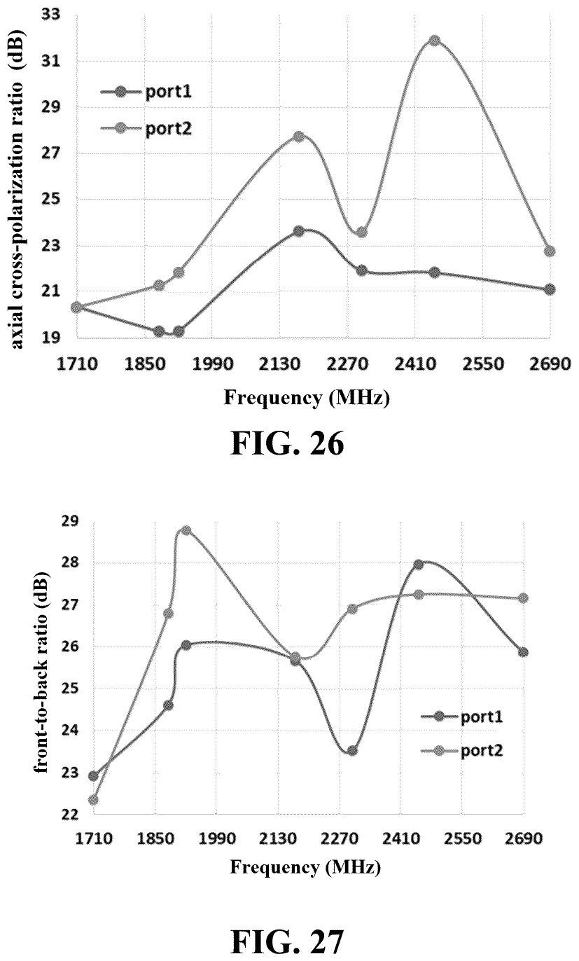

FIG. 26 is a graph showing axial cross-polarization ratio values of an antenna in some embodiments according to the present disclosure. Referring to FIG. 26, the axial cross-polarization ratio values of the antenna according to the present disclosure are consistently above 19.3 dB in the frequency range of 1710 to 2690 MHz.

FIG. 27 is a graph showing front-to-back ratio values of an antenna in some embodiments according to the present disclosure. Referring to FIG. 27, the front-to-back ratio values of the antenna according to the present disclosure are consistently above 22.3 dB in the frequency range of 1710 to 2690 MHz.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An antenna, comprising a plurality of radiating elements;
wherein a respective radiating element of the plurality of radiating elements comprises a dielectric substrate, one or more radiating oscillators on the dielectric substrate, and one or more conductors configured to optimize polarization isolation of the antenna;
wherein the one or more conductors are spaced apart from the one or more radiating oscillators; and
the plurality of radiating elements are arranged along a first direction, and the one or more conductors are arranged along a direction substantially parallel to a second direction, the second direction being different from the first direction, and the first direction and the second direction intersecting each other.

2. The antenna of claim 1, wherein the respective radiating element has a substantial mirror symmetry with respect to a first plane perpendicular to the dielectric substrate and intersecting the one or more conductors; and
the first plane is substantially parallel to the second direction.

3. The antenna of claim 1, wherein the respective radiating element has a substantial mirror symmetry with respect to a second plane perpendicular to the dielectric substrate and substantially parallel to the first direction;
the second plane is not intersecting with the one or more conductors; and
the second plane is substantially parallel to the first direction.

4. The antenna of claim 1, further comprising a plurality of coupling baluns connected to the plurality of radiating elements, respectively;
wherein a respective coupling balun of the plurality of coupling baluns comprises a first feeding balun and a second feeding balun intersecting each other;
in a cross-section along a plane intersecting the plurality of coupling baluns and parallel to surfaces of the plurality of radiating elements, the respective coupling balun has a X shape;
the first feeding balun comprises a first dielectric substrate, a first balun trace, and a first ground; and
the second feeding balun comprises a second dielectric substrate, a second balun trace, and a second ground.

5. The antenna of claim 4, wherein the respective radiating element further comprises one or more first slots extending through the one or more radiating oscillators;
the first ground comprises one or more first solder pads;
the second ground comprises one or more second solder pads; and
the one or more first solder pads and the one or more second solder pads are inserted into the one or more first slots.

6. The antenna of claim 4, further comprising a first power divider network configured to provide feeding to the plurality of radiating elements;
wherein the first power divider network is connected to the plurality of coupling baluns, and the plurality of coupling baluns are connected to the plurality of radiating elements;
the first power divider network comprises a first power divider sub-network configured to provide feeding to a first group of coupling baluns and a second power divider sub-network configured to provide feeding to a second group of coupling baluns; and
the first power divider network utilizes unequal power division.

7. The antenna of claim 6, wherein the first power divider sub-network comprises one or more first power divider traces;
the second power divider sub-network comprises one or more second power divider traces;
at least one of the one or more first power divider traces is connected to the first balun trace of a corresponding first feeding balun;
at least another of the one or more first power divider traces is connected to the second balun trace of a corresponding second feeding balun;
at least one of the one or more second power divider traces are connected to the first balun trace of a corresponding first feeding balun; and
at least another of the one or more second power divider traces are connected to the second balun trace of a corresponding second feeding balun.

8. The antenna of claim 6, further comprising one or more coaxial lines configured to provide ground for the antenna;
wherein the first power divider sub-network comprises one or more third solder pads;
the second power divider sub-network comprises one or more fourth solder pads; and
the one or more third solder pads and the one or more fourth solder pads are connected to the one or more coaxial lines.

9. The antenna of claim 6, further comprising a second power divider network configured to connect the first power divider sub-network with the second power divider sub-network.

10. The antenna of claim 9, further comprising a first coaxial line and a second coaxial line;
wherein the second power divider network is connected to the first coaxial line;
the first coaxial line is connected to the first power divider sub-network;
the second power divider network is connected to the second coaxial line; and
the second coaxial line is connected to the second power divider sub-network.

11. The antenna of claim 9, wherein the second power divider network includes one or more third power divider traces;
the first power divider sub-network comprises one or more first power divider traces;
the second power divider sub-network comprises one or more second power divider traces;
one of the one or more third power divider traces is connected to one of the one or more first power divider traces and one of the one or more second power divider traces; and
another of the one or more third power divider traces is connected to another of the one or more first power divider traces and another of the one or more second power divider traces.

12. The antenna of claim 1, further comprising one or more isolators;
wherein a respective isolator of the one or more isolators spaces apart two adjacent radiating elements in a same group of radiating elements.

13. The antenna of claim 12, further comprising a first reflector;
wherein a respective isolator of the one or more isolators comprises an isolation strip and one or more supports configured to support the isolation strip; and
the isolation strip and the plurality of radiating elements have a substantially same height relative to the first reflector.

14. The antenna of claim 1, further comprising a first reflector;
wherein a cross-section of the first reflector along a plane substantially parallel to the second direction and perpendicular to surfaces of the plurality of radiating elements has a U shape.

15. The antenna of claim 14, wherein the first reflector comprises a first portion, a second portion, and a third portion;
the second portion and the third portion extend along a direction substantially parallel to the first direction;
the first portion is connected to the second portion, and is connected to the third portion;
an included angle between the first portion and the second portion is in a range of 85 degrees to 95 degrees; and
an included angle between the first portion and the third portion is in a range of 85 degrees to 95 degrees.

16. The antenna of claim 14, further comprising:
a second reflector on a side of the first reflector away from the plurality of radiating elements;
one or more radiofrequency traces;
one or more fourth openings extending through the first reflector; and
one or more fifth openings extending through the second reflector;
wherein the one or more radiofrequency traces extend through the one or more fourth openings and the one or more fifth openings.

17. The antenna of claim 1, wherein a respective conductor of the one or more conductors has a V shape, a T shape, a π shape, or an open triangular ring shape.

18. The antenna of claim 1, wherein the one or more conductors comprise one or more first conductors and one or more second conductors;
a respective first conductor of the one or more first conductors spaces apart a respective second conductor of the one or more second conductors from the one or more radiating oscillators;
the one or more first conductors are configured to operate within high-frequency band; and
the one or more second conductors are configured to operate within low-frequency band.

19. The antenna of claim 1, wherein the respective radiating oscillator has a ring shape.

20. The antenna of claim 19, wherein an outer periphery of the respective radiating oscillator has a hexagonal shape;
an inner periphery of the respective radiating oscillator has a heptagonal shape; and
four vertices of four radiating oscillators surround a center of the respective radiating element.
